(19) United States
(12) Patent Application Publication
(10) Pub. No.: US 2010/0285196 A1
(43) Pub. Date: Nov. 11, 2010

(54) METHOD FOR PREPARING PUFFED CAKES USING A ROTARY COOKER

(75) Inventors: Gary Moore, Johnsburg, IL (US); Noman Khan, Carol Stream, IL (US); Waleed Yacu, Vernon Hills, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Quaker Oats Company, Chicago, IL (US)

(21) Appl. No.: 12/463,673

(22) Filed: May 11, 2009

(51) Int. Cl. A21D 13/08; A21D 8/02; A21D 10/02; A23L 1/18; A23L 1/00

(52) U.S. Cl. 426/534; 426/497; 426/625; 426/541; 426/559; 426/508; 426/634

(57) ABSTRACT

A method for preparing a grain or legume cake by cooking the whole grains or legumes is a rotary cooker and subsequently puffing the cooked whole grain or legume into a rice cake form. The whole grain or legume cakes produced by this method have a natural, appealing appearance and produce a more durable grain or legume cake.

### FIELD OF THE INVENTION

The present invention relates generally to the preparation of puffed cakes. More particularly, the present invention relates to a puffed cake and method for preparing a cake with a natural appearance, using a rotary cooker.

### BACKGROUND

In today's society, obesity, high cholesterol, and high blood pressure are health concerns on the minds of the vast majority of consumers. As a result of these health concerns, there exists a need for food and beverage manufacturers to provide consumers with healthy meal and snack options. One food group in particular, whole grains, may be consumed to address these concerns. Studies have found the following health benefits may be associated with the consumption of whole grains: reducing the risk of heart disease by decreasing cholesterol levels, blood pressure and blood coagulation; reducing the risk of many types of cancer; regulating blood glucose in diabetic individuals; and experiencing staying “fuller” for a longer period of time after consuming a comestible (i.e., satiety). Legumes provide similar health benefits to whole grains. For instance, legumes are a good source of both soluble and insoluble fiber and may lower the risk of heart disease. Moreover, legumes are rich in folic acid, copper, iron and magnesium in addition to being high in protein. The invention described herein provides the consumer with a healthy snack option—a puffed whole grain and/or legume cake.

Products that have a natural, simple appearance are also becoming more important to consumers. Currently, whole grains and legumes are added to rice cakes at very low levels (less than 15%) because the addition of higher levels of these ingredients reduces puffing and creates a dense, unappealing rice cake. One method used in the food industry to overcome the puffing problems caused by using higher levels of grains or legumes, include pre-gelatinizing the starch component of the ingredient in an extruder. However, the extruder plasticizes the grains or legumes and destroys the non-homogeneity of the components (i.e., the grain or legume). Therefore, a need exists in the food industry for a method of providing a consumer with a whole grain or legume snack that contains higher levels of grains or legumes compared to traditional cakes, while maintaining the cake's non-homogenous appearance.

The method described herein provides for gelatinization of the whole grain, without destroying the non-homogeneity of the whole grain or legume, thereby producing a natural-looking cake that is more appealing to consumers. The present invention is directed towards satisfying the need that exists in the field for natural-appearing puffed cakes. Moreover, the present invention prepares a puffed cake in less time and with lower drying costs as compared to traditional methods of producing a puffed cake. Additionally, by including oats or lentils in the method of the present invention, the nutritional value of the cake is greater in comparison to a rice cake, thereby providing the consumer with a healthier snack alternative.

Currently, rice cakes are made by popping raw grains, by pre-steaming the grains to moisten and partially gelatinize the starch and subsequently popping, or by pre-cooking whole grain flours in an extruder and forming pellets that are subsequently popped. While rice cakes from raw or steamed rice puff well in a rice cake machine, other whole grains, such as oats, do not. When an extruder is used to fully gelatinize whole grains, the plasticization of the grains destroys the non-homogeneity of the whole grain components. Therefore, while extruded whole grains will puff well in a rice cake machine, the finished product has a homogeneous, non-natural, unappealing appearance. The invention described herein provides greater gelatinization of starches than steaming alone and a similar level of starch gelatinization as extrusion, without destroying the non-homogeneity of the whole grain.

The method of preparing puffed cakes, as described herein, is advantageous in that it provides a more appealing product than can be produced by traditional methods of preparing puffed cakes. Additionally, this method of preparing puffed cakes allows the manufacturer to operate its rice cake popping machines at shorter bake times thereby lowering costs and improving popping productivity by 10-20% over conventionally steamed grains. This method of preparing cakes also provides longer product shelf-life. The method of preparing cakes as described herein can be completed by introducing whole grains or legumes into a rotary cooker, cooking, drying and puffing the product.

The present invention is directed toward satisfying the need that exists in the field, for healthy, natural, and natural-appearing snack products. Additionally, a food-grade ingredient may be included in the method of preparing the cakes, thereby providing the consumer with additional options for a healthy snack.

### BRIEF SUMMARY

The present invention relates to a method for preparing a puffed cake. It was discovered that the cake produced by the method described herein has a natural-looking, non-homogeneous appearance. In one aspect of the present invention, grain is introduced into a rotary cooker, cooked, dried and subsequently puffed into a desired form.

In another aspect of the present invention, a food-grade ingredient may be added in a step of the method for preparing grain cakes. For instance, a flavor may be added during cooking in the rotary cooker.

In yet another aspect of the present invention, legumes are introduced into a rotary cooker, cooked, dried and subsequently puffed into a desired form.

In another aspect of the present invention, a mixture of grains and legumes are introduced into a rotary cooker, cooked, dried and subsequently puffed into a desired form.

### BRIEF DESCRIPTION OF THE DRAWINGS

Numerous other objects, features and advantages of the present invention will be apparent based upon the following description of the drawings.

FIG. 1 is an RVA graph depicting the starch character in raw, steamed and rotary cooked Chana lentils.

FIG. 2 is an RVA graph depicting the starch character in raw, steamed and rotary cooked Masoor (Red Chief) lentils.

### DETAILED DESCRIPTION OF THE INVENTION

The present invention relates to grain cakes and legume cakes. In particular, the present invention relates to a method for preparing a puffed cake by cooking the whole grain or legumes in a rotary cooker. As used herein, “puffed,” “puffing,” or “puff” means puffing, popping, or otherwise expanding the grain or legume.

In accordance with one aspect of the present invention, whole grains are first introduced into a rotary cooker. The grains are subsequently cooked using steam and water in a rotary cooker for a cycle time of about 30-90 minutes, which includes reaching a cooking temperature and pressure of about 250°-280° F. and about 15-25 psi, respectively. The rotary cooker is typically operated at about 1-5 rpm. The grain is cooked at the target temperature and pressure for about 15-60 minutes. In one aspect of the invention, the grains are cooked in the rotary cooker to about 20-50% moisture. Any food-grade rotary cooker may be used in accordance with the present invention, such as the Lauhoff Model LC 91 Serial 9307. Following cooking, the grains are dried to about 13-17% moisture, generally for about 45-120 minutes. Techniques that may be used to dry the grains may include, but are not limited to convection oven drying at about 170°-220° F. for about 45-120 minutes. Lastly, the grains are puffed into a rice cake form. In one aspect of the present invention, the grains are puffed using traditional rice cake popping machines. For example, the Lite Energy Rice Cake Machine may be used to puff the cakes, at a temperature range of 400°-500° F., a bake time of about 2-5 seconds, and a mold pressure (the internal pressure within the mold created by compressing the grain between the molding plates) of about 600-1100 psi. As one of ordinary skill in the art of the food sciences would appreciate, the cooking conditions vary by grain, as lower cook times are needed for grains such as rice, corn, and wheat, whereas barley and oats require longer cook times for favorable gelatinization.

If the rotary cooked grains are to be stored for more than about 1 week prior to puffing, it is recommended that the grains be dried to reduce the water activity to less than about 0.6 prior to storage to prevent mold or bacterial contamination during storage. It is also recommended that the stored rotary cooked grains be soaked or steamed to about 13-17% moisture prior to puffing in accordance with the method described above.

Although the grains used in accordance with the instant invention do not need to be fully gelatinized for puffing, certain grains such as oat and barley require further gelatinization than the gelatinization achievable using traditional steaming methods, thus necessitating the rotary cook method as described herein. It was also discovered that the degree of grain gelatinization in the cooker affects the degree of grain fusion (bond strength) when puffed. This discovery allows the manufacturer to maintain some level of control over the texture of the puffed grain cake. For instance, partially-gelatinized oats puffed into a cake results in poor fusion of the oats (causing the cake to break apart easily when bitten and chewed), whereas fully-gelatinized grains fuse well and provide a superior eating experience for the consumer.

In another aspect of the present invention, legumes are introduced into a rotary cooker. The legumes are cooked using steam and water in a rotary cooker to about 20-45% moisture. The legumes are rotary cooked for a cycle time of about 20-60 minutes, which includes reaching a target temperature and pressure of about 240°-260° F. and 10-20 psi respectively, for about 5-25 minutes. Any food-grade rotary cooker may be used in accordance with the present invention, such as the Lauhoff Model LC 91 Serial 9307. The rotary cooker is typically operated at about 2-10 rpm, for example 6 rpm. Following cooking, the legumes are dried to about 10-17% moisture, generally for about 40-100 minutes. Techniques that may be used to dry the legumes may include, but are not limited to convection oven drying at about 170°-220° F. for about 40-100 minutes. Lastly, the legumes are puffed into a rice cake form. In one aspect of the present invention, the legumes are puffed using traditional rice cake popping machines. For example, the Lite Energy Rice Cake Machine may be used to puff the cakes, at a temperature range of about 400°-500° F., a bake time of about 1-5 seconds, and a mold pressure of about 600-1100 psi. As one of ordinary skill in the art of the food sciences would recognize, conditions may vary within these ranges depending on the legume and its corresponding starch content. In one aspect of the present invention, the legume is rotary cooked, dried to about 14-15% moisture, puffed at a temperature of about 450°-470° F. for a bake time of about 2 seconds at a mold pressure of about 950 psi.

If the rotary cooked legumes are to be stored for more than about 1 week prior to puffing, it is recommended that the legumes be dried to reduce the water activity to less than about 0.6 prior to storage to prevent mold or bacterial contamination during storage. It is also recommended that the stored rotary cooked legumes be soaked or steamed to about 13-18% moisture prior to puffing in accordance with the method described above.

Although the legumes used in accordance with the instant invention do not need to be fully gelatinized for puffing, the starch in the legume requires further gelatinization than the gelatinization achievable using traditional steaming methods, thus necessitating the rotary cook method as set forth herein. The inventors also discovered that the degree of starch gelatinization in the legume in the cooking step of the present invention affects on the degree of legume fusion (bond strength) when puffed and the extent of puffing achievable.

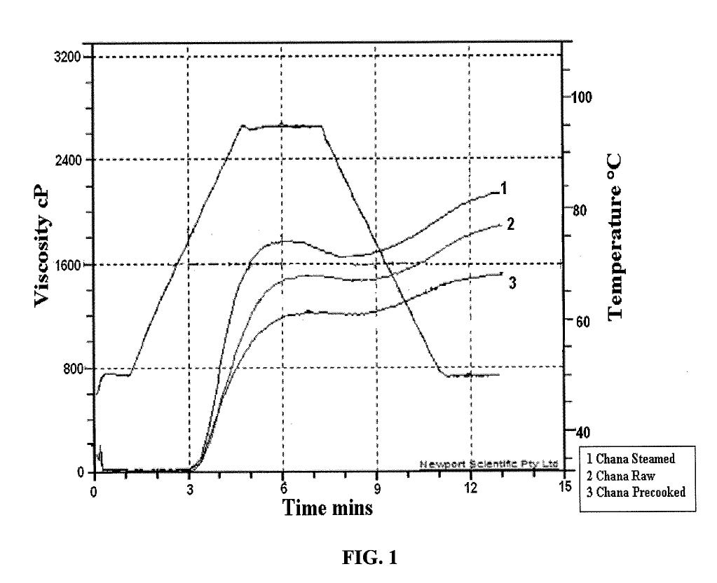

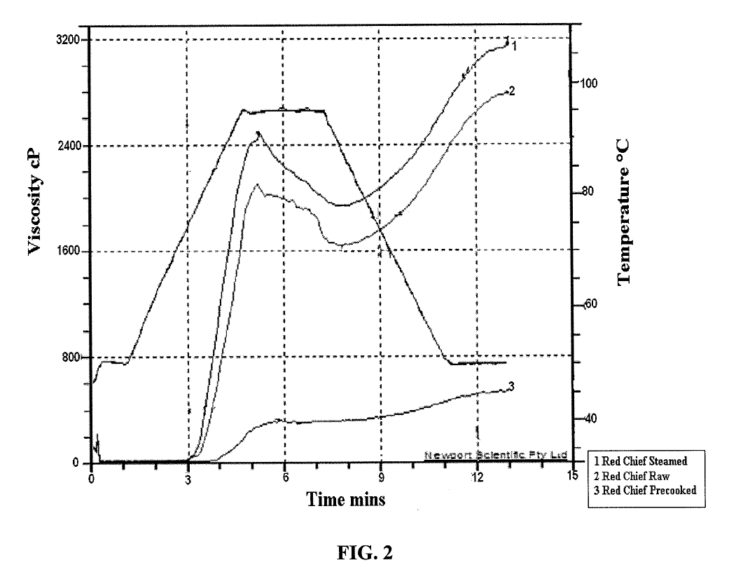

Significant differences in the starch character between raw lentils, steamed lentils and rotary cooked lentils prepared in accordance with the present invention were also discovered. These differences are further illustrated in FIGS. 1 and 2.

Further testing also showed that the gelatinization of the starch in the precooked (rotary cooked) lentils is superior to the starch gelatinization achieved via conventional cooking methods (See Table 1 below). For instance, traditional steaming of lentils resulted in about 21-27% starch gelatinization, which is not sufficient for acceptable puffing of the lentil. However, using the rotary cooking method described herein, starch gelatinization reached about 50-62%, thereby providing for superior puffing of the lentils.

TABLE 1
Starch Gelatinization in Lentils

| | | | | Starch | |
|---|---|---|---|---|---|
| | | | | Gelatinization | % |
| Analytical ID | Sample Description | % Moisture | % Starch | (J/g) | Gelatinization |
| 2009030482 | Red Chief Lentil - Raw | 8.00 | 26.47 | 8.955 | — |
| 2009030483 | Red Chief Lentil - Steamed | 17.43 | — | 7.105 | 20.66 |
| 2009030484 | Red Chief Lentil - Precooked | 11.46 | — | 4.510 | 49.64 |
| 2009030485 | Chana Lentil - Raw | 7.94 | 26.62 | 25.240 | — |
| 2009030486 | Chana Lentil - Steamed | 16.34 | — | 18.300 | 27.50 |
| 2009030487 | Chana Lentil - Precooked | 13.29 | — | 9.484 | 62.43 |

In yet another aspect of the present invention, both precooked legumes and precooked whole grains are introduced together in the puffing mold to make a unique puffed cake of legumes and grains fused together. The precooked legumes and grains can be prepared individually as previously described and subsequently blended together just prior to being puffed, or more preferably just prior to the re-hydration step. Alternatively the at least one legume and at least one grain can be introduced together into a rotary cooker to form a grain and legume mixture. The grains and legumes mixture is subsequently cooked using steam and water in a rotary cooker for a cycle time of about 30-70 minutes, which includes reaching a cooking temperature and pressure of about 240°-280° F. and about 10-25 psi, respectively. The rotary cooker is typically operated at about 1-8 rpm. The grain is cooked at the target temperature and pressure for about 10-40 minutes. In one aspect of the present invention, the grains are cooked in the rotary cooker to about 20-45% moisture. Any food-grade rotary cooker may be used in accordance with the present invention, such as the Lauhoff Model LC 91 Serial 9307. Following cooking, the grains are dried to about 12-15% moisture, generally for about 45-120 minutes. Techniques that may be used to dry the grains may include, but are not limited to convection oven drying at about 170°-220° F. for 45-120 minutes. Lastly, the grains are puffed into a rice cake form. In one aspect of the present invention, the grains are puffed using traditional rice cake popping machines. For example, the Lite Energy Rice Cake Machine may be used to puff the cakes, at a temperature range of about 400°-500° F., and a bake time of about 2-5 seconds at a mold pressure of about 600-1100 psi.

The whole grains used in accordance with the present invention include, but are not limited to oats, wheat, rice, corn, rye, and barley or combinations of these grains. Moreover, these grains may be steel cut whole grains and rolled grains. Grains with various textures also may be used in accordance with the instant invention. In one aspect, non-waxy grains are used.

The legumes used in accordance with the present include, but are not limited to lentils, peas, chickpeas, soybeans, pinto beans, navy, beans, black beans or combinations of these legumes. Furthermore, the lentils may be selected from the group consisting of one or more of the following: Moong Dal, Urad Dal, Chana Dal, or Masoor.

The inventors also discovered that when only legumes are used in accordance with the invention and puffed in the puffing machine, the resulting puffed cake exhibits reduced expansion due to the low level of starch in the legume, forming a thin, crispy cake. However, if legumes are mixed with grains such as rice, the starch content is increased and the puffed cake will exhibit a greater amount of puffing resulting from a lower density due to its foam-like structure.

The puffed cakes prepared using the method described in this application have increased durability as compared to puffed cakes prepared using traditional methods known in the food industry. By pre-cooking the whole grains or legumes in a rotary cooker, the grains and legumes also exhibit improved fusion. Notable advantages associated with improved fusion and durability of the grains and legumes include easier consumption of the puffed cake with less mess, and less concern regarding breakage of the cakes during transportation and/or storage.

Food-grade ingredients may also be added to the grain or legume product in another aspect of the present invention. For instance, during rotary cooking, a flavor may be introduced and/or infused into the grain or legume. Following drying and puffing, the finished cake contains flavors incorporated into the grains or legumes of the cake. This flavor may compliment a topical coating or stand alone as a simple, more naturally-flavored puffed cake. Food-grade flavorings such as sugars, salts, and spices may be incorporated into the cake. The infusion of flavors may also be beneficial as a means of eliminating or masking strong bitter flavors that may develop during puffing of the whole grains and legumes. For example, sugar and barley malt may be used to mask bitter oat flavors. Other flavorings used may include cinnamon powder, Thermarome™ (Firmenich) honey flavoring and Durarome™ (Firmenich) Basil and Roasted Garlic Flavoring. In one aspect of the present invention, sugar is added to the grains and completely infused completely into the grain. This complete infusion is beneficial to prevent the grains from sticking in the puffing mold. Antioxidants are also more effective in preventing oxidation when they are infused into the grain instead of being dissolved into the outer surface of the grain.

As described herein, the present invention provides a method for preparing a puffed whole grain and/or legume cake using a rotary cooker, resulting in beneficial attributes, while maintaining the structure of the whole grain or legume throughout processing. Additionally, a flavored grain and/or legume cake may be prepared in accordance with the present invention. Specific examples of the invention are as follows:

### EXAMPLE 1

Step 1. Dissolve the sugar, malted barley extract, and salt in the water from Table A and then add ingredients in Table A to the rotary cooker.

TABLE A

| Ingredient | % of Formula | Lbs per batch |
|---|---|---|
| Oats | 85.970 | 85.97 |
| Sugar | 3.150 | 3.15 |
| Malted barley extract | 1.500 | 1.50 |
| Salt | 0.800 | 0.80 |
| Water | 8.500 | 8.50 |
| Mixed Tocopherol | 0.080 | 0.08 |
| Total | 100.000 | 100.00 |

Step 2. Cook mixture in preheated rotary cooker (Lauhoff Model LC 91 Serial 9307) for a cycle time of about 30-90 minutes with supply steam pressure at about 30-40 psi. Cycle time will include a ramp up of temperature and pressure inside the cooker. Final pressure and temperature should be at least 15 psi and 250° F., respectively, and should be held at these conditions for about 5-25 minutes. This cooking cycle is followed by a 5 minute depressurization, 10 minute purge, and 5 minute depressurization to discharge. Resulting grain mixture should be about 30-38% moisture.

Step 3. Dry grain mixture of Step 2 using Aeroglide Electric Batch oven. Depending on bed depth and beginning moisture, grains can be dried at 170°-220° F. for 45-120 minutes to reach desired moisture of less than 11%. Low moisture is needed for safe storage of grains, specifically mold growth prevention. If grains are not going to be stored before puffing, moisture should be reduced to about 15%, but tempering is necessary to allow moisture to equilibrate throughout the batch.

Step 4. If grains have been stored, grains must be soaked or steamed to achieve a moisture level of about 13-17% before popping.

Step 5. Grains are popped into cakes using a Lite Energy Rice Cake Machine containing molds between 1″ and 2″ in diameter. The machine is set to about 400°-500° F. on its top and bottom molds. The internal mold pressure is set to about 950 psi. Bake time can range between 2 s and 5 s to achieve the desired expansion and texture.

### EXAMPLE 2

Method described in Example 1, except using whole grain barley instead of oats.

### EXAMPLE 3

Method described in Example 1, except using whole wheat instead of oats and reducing cook time to 30-60 minutes.

### EXAMPLE 4

Step 1. Steam oats by spraying 5 psi steam on steel cut oats in a tumbler. Oats are steamed in 10 lb batches for 75 s, raising moisture about 3%. Oats start at a moisture ranging from 8-12%.

Step 2. Dissolve added ingredients such as sugar, barley malt, salt, and antioxidants into 180° F. water. Amount of water is about 8-10% as part of a formula containing about 80-85% whole grains, and other minor dry ingredients. In this example, the flavors are infused into the grain during the pre-soak step prior to rotary cooking.

Step 3. Mix water slurry mixture with steamed oats and soak, covered for about 30-60 minutes.

Step 4. Cook mixture in preheated rotary cooker (Lauhoff Model LC 91 Serial 9307) for a cycle time of about 20-60 minutes with supply steam pressure at about 30-40 psi. Cycle time will include a ramp up of temperature and pressure inside the cooker. Final pressure and temperature should be at least about 15 psi and 260° F., respectively, and should be held at these conditions for about 5-15 minutes. This cooking cycle is followed by a 5 minute depressurization, 10 minute purge, and 5 minute depressurization to discharge. The resulting grain mixture should be about 30-38% moisture.

Step 5. Dry grain mixture prepared in Steps 1-4 using Aeroglide Electric Batch oven. Depending on bed depth and beginning moisture, grains can be dried at 170°-220° F. for 45-120 minutes to reach desired moisture of less than 11%. Low moisture is needed for safe storage of grains, specifically mold growth prevention. If grains are not going to be stored before puffing, moisture should be reduced to about 15%, but tempering is necessary to allow moisture to equilibrate throughout the batch.

Step 6. If grains have been stored, grains must be soaked or steamed to achieve a moisture of about 13-17% before puffing.

Step 7. Grains are popped into cakes using a Lite Energy Rice Cake Machine containing molds between 1″ and 2″ in diameter. The machine is set to about 400°-500° F. on top and bottom molds. The internal mold pressure is set to about 950 psi. Bake time can be varied between 2 s and 5 s to achieve desired expansion and texture.

### EXAMPLE 5

Step 1. Dissolve the sugar and salt in the water in the quantities listed in Table A and add ingredients in Table B to the rotary cooker.

TABLE B

| Ingredient | % of Formula | Lbs per batch |
|---|---|---|
| Chana Dal beans | 85.57 | 34.228 |
| Sugar | 3.45 | 1.38 |
| Salt | 0.86 | 0.344 |
| Water | 10.000 | 4.00 |
| Mixed Tocopheroll | 0.080 | 0.032 |
| Citric Acid | 0.040 | 0.016 |
| Total | 100.000 | 40.000 |

Step 2. Rotate the rotary cooker with ingredients for about 30 seconds before adding steam.

Step 3. Cook mixture prepared in Steps 1-2 in preheated rotary cooker (Lauhoff Model LC 91 Serial 9307) for a cycle time of about 25 minutes with supply steam pressure at about 20 psi. Cycle time will include a ramp up of temperature and pressure inside the cooker. Final pressure and temperature should be at least about 6 psi and 225° F., respectively, and should be held at these conditions for about 5-10 minutes. This cooking cycle is followed by a 5 minute depressurization to discharge. The resulting lentil mixture should be about 24% moisture.

Step 4. Dry lentil mixture using Aeroglide Electric Batch oven. Depending on bed depth and beginning moisture, lentils can be dried at 170°-220° F. for about 40 minutes to reach desired moisture of less than about 14%. Low moisture is needed for safe storage of pre-cooked legumes, specifically mold growth prevention. If the legumes are not going to be stored before popping, moisture should be reduced to about 15%, but tempering is necessary to allow moisture to equilibrate throughout the batch.

Step 5. If the lentils have been stored, they must be soaked or steamed to achieve a moisture of about 13-15% before puffing.

Step 6. Lentils are popped into cakes using a Lite Energy Rice Cake Machine containing molds between 1″ and 2″ in diameter. The machine is set to about 400°-500° F. on top and bottom molds. The internal mold pressure is set to about 950 psi. Bake time can be varied between 1.0 s and 5.0 s to achieve desired expansion and texture.

The invention may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

What is claimed is:

1. A method for preparing puffed grain cakes comprising the steps of:
a) introducing a whole grain into a rotary cooker;
b) cooking the whole grain with steam and water in the rotary cooker to about 20-50% moisture;
c) drying the whole grain to about 10-17% moisture; and
d) puffing the whole grain to form a puffed whole grain cake.

2. The method of claim 1 wherein the whole grain is selected from the group consisting of oats, wheat, rice, corn, barley and mixtures thereof.

3. The method of claim 1 wherein the whole grain is a non-waxy grain.

4. The method of claim 1 wherein the puffed whole grain cake has a natural appearance.

5. The method of claim 1 wherein the whole grain is cooked in the rotary cooker to about 25-38% moisture.

6. The method of claim 1 wherein the whole grain is steel cut.

7. The method of claim 1 further comprising:
adding at least one food-grade ingredient to the rotary cooker.

8. The method of claim 7 wherein the at least one food-grade ingredient is a flavor.

9. The method of claim 8 wherein the flavor is selected from a group consisting of sugar, spice, chocolate barley malt, antioxidants, cinnamon powder, honey flavoring, garlic flavoring and mixtures thereof.

10. A puffed whole grain cake produced by the method of claim 1.

11. A puffed whole grain cake comprising:
at least one whole grain cooked with steam and water in a rotary cooker to about 25-38% moisture, dried to about 10-14% moisture, and puffed.

12. A method for preparing a puffed whole grain cake comprising the steps of:
a) introducing a whole grain and a food-grade ingredient into a rotary cooker;
b) cooking the whole grain and food-grade ingredient with steam and water in the rotary cooker until the food-grade ingredient is infused into the whole grains to create an ingredient-infused whole grain;
c) drying the ingredient-infused whole grain; and
d) puffing the ingredient-infused whole grain to form a puffed, ingredient-infused whole grain cake.

13. The method of claim 12 wherein the food-grade ingredient is selected from the group consisting of sugar, antioxidants and combinations thereof.

14. The method of claim 12 wherein the ingredient-infused whole grain has a moisture content of about 20-50% after rotary cooking and a moisture content of about 10-17% after drying.

15. A puffed ingredient-infused whole grain cake produced by the method of claim 12.

16. A puffed ingredient-infused whole grain cake produced by the method of claim 14.

17. A method for preparing puffed legume cakes comprising the steps of:
a) introducing a legume into a rotary cooker;
b) cooking the legume with steam and water in the rotary cooker to about 20-45% moisture;
c) drying the legume to about 10-17% moisture; and
d) puffing the legume to form a puffed legume cake.

18. The method of claim 17 wherein the legume is selected from the group consisting of lentils, peas, chickpeas, soybean, pinto bean, navy bean, black bean and mixtures thereof.

19. The method of claim 18 wherein the lentil is selected from the group consisting of Moong Dal, Urad Dal, Chana Dal, or Masoor and mixtures thereof.

20. A puffed legume cake produced by the method of claim 17.

21. A method for preparing puffed whole grain and legume cakes comprising the steps of:
a) introducing at least one whole grain and at least one legume into a rotary cooker to form a grain-legume mixture;
b) cooking the grain-legume mixture with steam and water in the rotary cooker to about 20-45% moisture;
c) drying the grain-legume mixture to about 10-17% moisture; and
d) puffing the grain-legume mixture to form a puffed grains and legume cake.

22. A puffed whole grain and legume cake produced by the method of claim 21.

23. The method of claim 21 wherein the at least one whole grain is selected from the group consisting of oats, wheat, rice, corn, barley and mixtures thereof.

24. The method of claim 21 wherein the at least one legume is selected from the group consisting of lentils, peas, chickpeas, soybean, pinto bean, navy bean, black bean and mixtures thereof.

25. A method for preparing puffed whole grain and legume cakes comprising the steps of:
a) introducing at least one whole grain into a rotary cooker;
b) cooking the whole grain with steam and water in the rotary cooker to about 20-50% moisture;
c) drying the at least one whole grain to about 10-17% moisture;
d) introducing at least one legume into a rotary cooker;
e) cooking the at least one legume with steam and water in the rotary cooker to about 20-45% moisture;
f) drying the at least one legume to about 10-17% moisture;
g) blending the at least one legume and at least one whole grain to form a grain-legume mixture; and
h) puffing the grain-legume mixture to form a puffed grain and legume cake.

26. A puffed whole grain and legume cake produced by the method of claim 25.
